(19) United States
(12) Patent Application Publication
(10) Pub. No.: US 2026/0192388 A1
(43) Pub. Date: Jul. 9, 2026

(54) BATTERY CASE WELDING COORDINATE CORRECTION SYSTEM AND METHOD THEREOF

(71) Applicant: SK ON CO., LTD., Seoul (KR)

(72) Inventors: Ji Yoon YOUM, Daejeon (KR); Oh San AN, Daejeon (KR); Seul Gi LEE, Daejeon (KR); Deok Min JEON, Daejeon (KR); Min Jeong HONG, Daejeon (KR)

(21) Appl. No.: 19/441,887

(22) Filed: Jan. 7, 2026

(30) Foreign Application Priority Data
Jan. 7, 2025 (KR) 10-2025-0002436

(51) Int. Cl. B23K 26/24; B23K 26/03; B23K 26/062; B23K 26/073; B23K 26/082; B23K 101/36; G06T 7/00; G06T 7/73

(52) U.S. Cl. CPC B23K 26/24; B23K 26/032; B23K 26/0626; B23K 26/073; B23K 26/082; G06T 7/0004; G06T 7/73; B23K 2101/36; G06T 2207/30136

(57) ABSTRACT

The present disclosure relates to a battery case welding coordinate correction system and a method thereof. A battery case welding coordinate correction system according to an embodiment of the present disclosure may include a laser oscillator configured to output a laser beam; a coaxial camera disposed on a same axis as an emission path of the laser beam of the laser oscillator; a control board configured to calculate coordinates on a welding path based on an image obtained from the coaxial camera; a welding scanner configured to correct a position of the laser beam in real time according to target welding coordinates received from the control board; and a signal converter configured to convert the target welding coordinates into an encoder value and provide the encoder value to the control board.

### CROSS-REFERENCE TO RELATED APPLICATION

This application claims priority to Korean Patent Application No. 10-2025-0002436 filed Jan. 7, 2025, the disclosure of which is hereby incorporated by reference in its entirety.

### BACKGROUND

### Technical Field

The present disclosure relates to a battery case welding coordinate correction system and a method thereof.

### Technical Considerations

In the welding process of a battery case, maintaining welding quality is crucial to ensure the safety and durability of the battery, and laser welding technology is primarily used.

Laser welding technology is a method of fusing metal surfaces using a high-power laser beam, offering high precision and fast processing speeds. In particular, laser welding is advantageous for maintaining uniform welding quality in curved or complex shapes, such as cylindrical battery cases.

However, conventional laser welding systems often fail to adequately respond to abnormal conditions such as thermal deformation of materials, tolerances, and gap deviations. These issues can lead to deterioration in welding quality, incomplete fusion, and structural defects. Furthermore, failure to precisely control the position of the laser beam along the welding path makes it difficult to maintain the consistency of the welding line.

### SUMMARY

Embodiments of the present disclosure may provide a battery case welding coordinate correction system and a method thereof.

Embodiments of the present disclosure may provide a battery case welding coordinate correction system and a method thereof, capable of minimizing incomplete fusion or structural defects that may occur during a welding process.

The battery case welding coordinate correction system and the method thereof according to the present disclosure may be widely applied in green technology fields such as electric vehicles, battery charging stations, and other battery-using applications such as solar power generation and wind power generation.

Furthermore, the battery case welding coordinate correction system and the method thereof according to the present disclosure may be used in eco-friendly electric vehicles (EVs), hybrid vehicles, and the like for preventing climate change by suppressing air pollution and greenhouse gas emissions. According to an embodiment of the present disclosure, there is provided a battery case welding coordinate correction system, comprising: a laser oscillator configured to output a laser beam; a coaxial camera disposed on a same axis as an emission path of the laser beam of the laser oscillator; a control board configured to calculate coordinates on a welding path based on an image obtained from the coaxial camera; a welding scanner configured to correct a position of the laser beam in real time according to target welding coordinates received from the control board; and a signal converter configured to convert the target welding coordinates into an encoder value and provide the encoder value to the control board.

In some non-limiting embodiments, the coaxial camera may be configured to recognize two point coordinates on the welding path in pixel units.

In some non-limiting embodiments, the control board may be configured to calculate the target welding coordinates by applying a center value or a set offset value based on the two point coordinates.

In some non-limiting embodiments, the coaxial camera may be configured to analyze gap information of the welding path.

In some non-limiting embodiments, the control board may be configured to adjust laser power or a laser shape in real time based on the gap information.

In some non-limiting embodiments, the coaxial camera may be configured to analyze a welding shape in real time during welding.

In some non-limiting embodiments, the control board may be configured to optimize process conditions in real time based on data on the analyzed welding shape.

In some non-limiting embodiments, the control board may be configured to calculate a correction value of the laser beam by comparing a current position of the welding scanner with the target welding coordinates.

In some non-limiting embodiments, the control board may be configured to analyze a coordinate change caused by at least one of thermal deformation of a material, positional misalignment of the material, a tolerance, and a gap deviation, and correct the coordinate change in real time.

In some non-limiting embodiments, the control board may be configured to correct the coordinate change in real time by controlling a scanner mirror of the welding scanner to maintain constant welding quality.

According to another embodiment of the present disclosure, there is provided a battery case welding coordinate correction method, comprising: setting initial welding coordinates; capturing an image of a welding path in real time using a coaxial camera; recognizing two point coordinates on the welding path from the image captured through the coaxial camera; calculating target welding coordinates based on the two point coordinates; converting the target welding coordinates into an encoder value; and correcting a position of a laser beam through a welding scanner using the encoder value, wherein the method repeats steps starting from the step of capturing the image of the welding path while welding is in progress.

In some non-limiting embodiments, the two point coordinates on the welding path may be recognized in pixel units.

In some non-limiting embodiments, the target welding coordinates may be calculated by applying a center value or a set offset value based on the two point coordinates.

In some non-limiting embodiments, the calculating the target welding coordinates may comprise analyzing gap information of a material and additionally reflecting a combined analysis result of the analyzed gap information and welding shape data.

In some non-limiting embodiments, the correcting the position of the laser beam may comprise calculating a difference between the target welding coordinates and a current position of the welding scanner and correcting the position of the laser beam in real time, wherein the correcting is repeatedly performed while welding is in progress.

In some non-limiting embodiments, the difference may be calculated based on the encoder value of the target welding coordinates and an encoder value of the current position.

In some non-limiting embodiments, the method may further comprise obtaining welding shape data during welding using the coaxial camera and feeding back process conditions during or after the step of correcting the position of the laser beam.

In some non-limiting embodiments, the feeding back the process conditions may comprise adjusting laser power or a laser shape based on an analysis result of the welding shape.

In some non-limiting embodiments, incomplete fusion or structural defects that may occur during a welding process may be minimized.

In some non-limiting embodiments, consistency of welding quality may be maintained and a welding defect rate may be minimized by calculating coordinates on a welding path and correcting a position of a laser beam in real time.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 illustrates a configuration of a battery case welding coordinate correction system according to an embodiment of the present disclosure.

FIG. 2 is a schematic diagram showing a welding operation process of a battery case welding coordinate correction system according to an embodiment of the present disclosure.

FIG. 3 illustrates a schematic configuration diagram and signal flow of a battery case welding coordinate correction system according to an embodiment of the present disclosure.

FIG. 4 is a flowchart explaining a battery case welding coordinate correction method according to an embodiment of the present disclosure.

FIG. 5 illustrates a workflow for a battery case welding coordinate correction system according to an embodiment of the present disclosure.

FIG. 6 is a schematic diagram showing a welding operation process of a battery case welding coordinate correction system according to another embodiment of the present disclosure.

FIG. 7 illustrates an electric vehicle powered by a battery pack including a battery cell or a battery module welded by a battery case welding coordinate correction system and a method thereof according to an embodiment of the present disclosure.

### DETAILED DESCRIPTION

Hereinafter, embodiments or aspects will be described in detail with reference to the accompanying drawings. However, since various changes may be made in the embodiments or aspects, the scope of the patent disclosure is not limited or restricted by these embodiments or aspects. It should be understood that all modifications, equivalents, and alternatives for the embodiments or aspects are comprised in the scope of the present disclosure. For example, it is to be understood that the present disclosure may assume various alternative variations and step sequences, except where expressly specified to the contrary. It is also to be understood that the specific devices and processes illustrated in the attached drawings, and described in the following detailed description, are simply exemplary and non-limiting embodiments or aspects of the disclosed subject matter. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “comprise”, “comprises”, “comprising”, “include”, “includes”, “including”, “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

It will be understood that when a component is described to as being “connected,” “combined” or “coupled” to another component, the component may be directly connected or coupled to the another component, but it may be “connected,” “combined” or “coupled” to the another component by an intervening another component that may be present.

Further, in describing the components of the embodiment or aspect, the meaning of “or” may mean each of the components, may mean two or more of the components, or may mean all of the components. For example, it should be understood that the expressions “a, b or c” represent any one of “a,” “b,” “c,” “a and b,” “a and c,” “b and c,” and “a, b and c.”

Components comprised in one embodiment or aspect and components comprising common functions will be described using the same names in other embodiments or aspects. The description given in one embodiment or aspect may be applied to other embodiments or aspects, and therefore will not be described in detail within the overlapping range, unless there is a description opposite thereto.

The device and/or ‘data’ processed by the device may be expressed in terms of ‘information″. Here, the information may be used as a concept comprising the data.

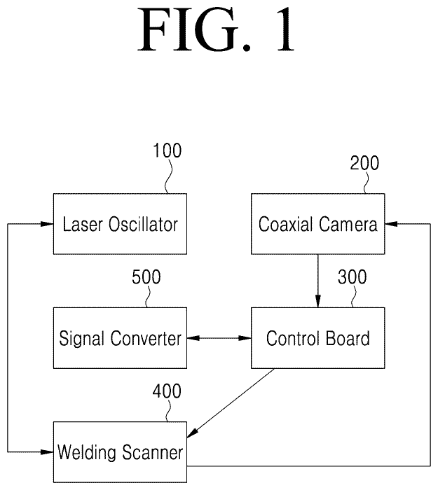

FIG. 1 illustrates a configuration of a battery case welding coordinate correction system according to an embodiment of the present disclosure.

Referring to FIG. 1, the battery case welding coordinate correction system according to an embodiment of the present disclosure may include a laser oscillator 100 configured to output a laser beam, a coaxial camera 200 disposed on a same axis as a laser beam emission path of the laser oscillator 100, a control board 300 configured to calculate coordinates on a welding path based on an image obtained from the coaxial camera 200, a welding scanner 400 configured to correct a position of the laser beam in real time according to target welding coordinates received from the control board 300 and a signal converter 500 configured to convert the target welding coordinates into an encoder value and provide the encoder value to the control board 300.

The present disclosure is intended to maintain a more accurate welding path by correcting coordinate errors and thermal deformation occurring in a welding process of a battery case 10 in real time. By including the laser oscillator 100, the coaxial camera 200, the control board 300, the welding scanner 400, and the signal converter 500, the present disclosure ensures consistency of precision and welding quality by correcting the position of the laser beam in real time based on the target welding coordinates.

The present disclosure may be used to weld a gap 30 between a battery case 10 and a cap 20 of various shapes, and an embodiment of the present disclosure will be described focusing on a cylindrical battery case 10.

The laser oscillator 100 according to an embodiment of the present disclosure is a device that outputs a laser beam along a welding path and generates energy required for welding. The laser beam is used to weld the gap 30 between the battery case 10 and the cap 20, and may be output to follow the target welding coordinates through control of the welding scanner 400.

According to an embodiment of the present disclosure, the coaxial camera 200 is disposed on the same axis as the emission path of the laser beam output from the laser oscillator 100, thereby detecting the welding path and allowing welding coordinates to be recognized in real time. Here, the coaxial arrangement refers to a structure set such that a traveling direction of the laser beam matches a field of view of the coaxial camera 200.

The coaxial camera 200 according to an embodiment of the present disclosure is disposed on the same axis as the laser beam emission path of the laser oscillator 100. The coaxial camera 200 performs a role of recognizing coordinates on the welding path by photographing the welding path in real time. For example, coordinates may be obtained with pixel-unit precision to detect a welding error caused by thermal deformation of a material or a gap deviation.

In addition, the coaxial camera 200 according to an embodiment of the present disclosure may be formed as a high-speed camera capable of capturing thousands to tens of thousands of frames per second to instantaneously detect minute coordinate changes or changes in welding shape occurring during welding, monitoring them in real time, and analyzing data. Also, the captured image may be transmitted to the control board 300 in real time and used to recognize coordinates on the welding path or calculate the target welding coordinates.

The coaxial camera 200 is designed with a structure disposed on the same axis as the laser beam emission path, wherein the same axis means that the traveling direction of the laser beam matches (overlaps) the field of view of the coaxial camera 200. Accordingly, the coaxial camera 200 may observe a path to be irradiated with the laser beam more accurately without distortion and collect data in real time.

That is, the coaxial arrangement allows the coaxial camera 200 to be disposed along the same central axis as the laser beam so that the laser beam and an observation path coincide, thereby minimizing observation errors and enabling high-precision coordinate recognition. This structure is for performing data collection for calculating the target welding coordinates and correcting the welding path in real time.

The coaxial camera 200 according to an embodiment of the present disclosure recognizes two point coordinates (X₁, Y₂) and (X₂, Y₁) on a path being welded in real time in pixel units. Through this, the control board 300 calculates target welding coordinates (X′, Y′) and corrects the position of the laser beam in real time through the welding scanner 400.

That is, while the beam of the laser oscillator 100 moves along a specific path, the coaxially arranged high-speed camera observes the corresponding path within the same field of view and detects a deviation of the welding path. Since this arrangement matches the emission path of the laser beam with the field of view of the coaxial camera 200, more accurate pattern recognition and consistent collection of coordinate data for a welding part are possible.

Specifically, in a welding process of the cylindrical battery case 10 and the cap 20, the laser oscillator 100 outputs a laser beam along the welding path. At this time, the coaxial camera 200 captures a path through which the laser beam passes in real time and detects the two point coordinates (X₁, Y₂) and (X₂, Y₂). For example, the coordinate data recognized by the coaxial camera 200 is used as a reference value for calculating the target welding coordinates (X′, Y′).

Thereafter, the control board 300 calculates a correction value by comparing the target welding coordinates with a current position of the scanner, and based on this, the welding scanner 400 adjusts the position of the laser beam. As such, since the coaxial camera 200 is observed on the same axis as the laser beam, it is possible to minimize errors in coordinate data and detect changes at a high speed.

According to an embodiment of the present disclosure, the coaxial camera 200 may be formed to recognize two point coordinates on the welding path in pixel units. This allows the coaxial camera 200 to recognize the two point coordinates on the welding path to increase the accuracy of coordinate calculation, and to maintain the precision of the welding path and the consistency of welding quality by setting the target welding coordinates based thereon.

The coaxial camera 200 is disposed on the same axis as the laser beam emission path of the laser oscillator 100, and performs a function of recognizing the two point coordinates on the welding path in real time. The coaxial camera 200 detects coordinates in pixel units, providing precision capable of recognizing even minute errors more accurately. In particular, since it is arranged in a coaxial structure, a field of view of the coaxial camera 200 matches the laser beam, so that the welding path can be observed more accurately.

The two point coordinates are two points detected by the coaxial camera 200 on the welding path, and mean coordinates of a start and an end of welding or a specific section. The two point coordinates are used as reference data for calculating the target welding coordinates in the control board 300, and become information for detecting errors on the welding path. Since the coaxial camera 200 recognizes these coordinates in pixel units, it can provide very precise coordinate data.

As a specific embodiment, a coaxial high-speed camera is utilized in a welding process of the cylindrical battery case 10 and the cap 20. While the laser oscillator 100 irradiates the laser beam to the gap 30 between the case 10 and the cap 20, the coaxial high-speed camera captures the welding path in real time. The camera recognizes the two point coordinates on the welding path in pixel units, and for example, detects coordinates (X₁, Y₁) and (X₂, Y₂). These two point coordinates are transmitted to the control board 300 and used to calculate the target welding coordinates. If the path deviates due to thermal deformation or gap deviation during welding, the coaxial camera 200 immediately detects this and recognizes the changed positions of the two point coordinates in pixel units. The coordinates thus obtained are transmitted to the control board 300 in real time, and the laser position is corrected through the welding scanner 400.

Accordingly, according to an embodiment of the present disclosure, the pixel-unit coordinate recognition of the coaxial camera 200 increases the accuracy of coordinate calculation by more precisely detecting the two point coordinates on the welding path. Through this, minute errors in the welding path can be corrected in real time, so that the precision of the welding path is maintained, and consequently, the consistency of welding quality can be ensured.

According to an embodiment of the present disclosure, target welding coordinates may be calculated by applying a center value or a set offset value based on two point coordinates. This allows the target welding coordinates to be calculated by applying the center value or the set offset value based on the two point coordinates recognized by the coaxial camera 200. Through this, the target welding coordinates calculated from the two point coordinates improve precision of a welding path, minimize welding errors, and provide an effect of ensuring consistent welding quality.

The two point coordinates according to an embodiment of the present disclosure refer to two points recognized on the welding path by a coaxial high-speed camera, for example, coordinates of (X₁, Y₁) and (X₂, Y₂). These two point coordinates recognize the welding path and serve as a reference for coordinate calculation. Since the two point coordinates are obtained with pixel-unit precision by the camera, the welding path can be expressed very accurately.

The target welding coordinates according to an embodiment of the present disclosure are final coordinates calculated based on the two point coordinates, and represent a path to be followed by the welding scanner 400. Calculating based on the center value of the two point coordinates allows for balancing the welding path, and applying the set offset value allows for fine adjustment in a specific direction. These target welding coordinates are calculated in the control board 300 and transmitted to the welding scanner 400 to be used for controlling a position of the laser beam.

The control board 300 receives the two point coordinates provided from the coaxial high-speed camera, and determines the target welding coordinates by calculating the center value or the offset value based thereon. The control board 300 may apply the offset value according to preset process conditions, and transmits the calculated target welding coordinates to the welding scanner 400 to maintain an accurate position of the laser beam.

In a specific embodiment, in a welding process of a cylindrical battery case 10 and a cap 20, the coaxial high-speed camera recognizes the two point coordinates on the welding path in real time. The camera detects coordinates of (X₁, Y₁) and (X₂, Y₂) in pixel units, and these two point coordinates are transmitted to the control board 300. The control board 300 calculates the target welding coordinates by calculating a center value of the two coordinates. For example, X′ and Y′ are set as average values of the two coordinates, providing a balanced welding path. If an offset value is set, the control board 300 finely adjusts the coordinates in a specific direction by adding the offset to the center value. The target welding coordinates are provided to the welding scanner 400, and the scanner performs welding by controlling the laser beam in real time according to the corrected path.

For example, if a gap moves in a specific direction due to thermal deformation, the control board 300 finely corrects the target welding coordinates by applying the offset value. This process is repeated in real time during welding to continuously maintain accuracy of the welding path.

As described above, calculating the target welding coordinates based on the center value or the set offset value of the two point coordinates according to an embodiment of the present disclosure improves the precision of the welding path and enables real-time correction of minute errors. In particular, when the offset value is applied, the welding path can be finely adjusted according to thermal deformation or gap deviation, so that the accurate laser beam position can be maintained. Through this, consistency of welding quality is secured, and a welding defect rate can be minimized.

According to an embodiment of the present disclosure, the coaxial camera 200 may be configured to analyze gap information of a welding path. The coaxial camera 200 precisely detects and analyzes a size and a position of a gap 30 on the welding path to provide data necessary for calculating target welding coordinates and correcting process conditions, thereby maintaining an accurate welding path and ensuring consistency of welding quality.

The coaxial camera 200 may be disposed on the same axis as a laser beam emission path of the laser oscillator 100 to perform a role of detecting and analyzing the gap information of the welding path in real time. The gap information refers to a space between materials to be welded, for example, a gap between the battery case 10 and the cap 20, and the information directly affects the welding quality. The coaxial camera 200 analyzes a position and a size of the gap 30 with pixel-unit precision, and may measure gap information that fluctuates according to thermal deformation or a tolerance of a material.

The analysis of the gap information is performed based on an image captured by the coaxial camera 200. The coaxial camera 200 recognizes coordinates and a width of the gap 30 on the welding path and transmits them to the control board 300. The control board 300 may calculate the target welding coordinates using this data or correct them in real time by adjusting welding conditions (e.g., laser power, shape, etc.).

The control board 300 analyzes the gap information received from the coaxial camera 200 and may transmit a command to the welding scanner 400 or the laser oscillator 100 if necessary. For example, when the gap 30 becomes larger or smaller than a reference value, the control board 300 may correct an imbalance of the gap 30 by adjusting laser power or changing a welding pattern such as a line or a wobble.

In a specific embodiment, in a process of welding a cylindrical battery case 10 and a cap 20, the coaxial high-speed camera analyzes gap information between the battery case 10 and the cap 20 in real time. For example, the coaxial camera 200 detects a case where a width of the gap 30 on the welding path increases to 0.25 mm or decreases to 0.15 mm due to thermal deformation or material tolerance, although the width is set to a reference value of 0.2 mm.

The detected gap information is transmitted to the control board 300, and the control board 300 analyzes the size and the position of the gap 30 to adjust a laser output value. When the gap 30 is widened, the laser output is temporarily increased to ensure sufficient welding, and when the gap 30 is narrowed, the output is decreased to prevent excessive thermal energy. In addition, the control board 300 changes a laser shape to a line or wobble pattern as necessary to maintain constant welding quality.

This process is repeated in real time, and the coaxial high-speed camera continuously detects the gap information and feeds it back to the control board 300. Through this, a gap imbalance in the welding path may be corrected in real time.

As described above, the coaxial camera 200 according to an embodiment of the present disclosure analyzes the gap information of the welding path to detect and correct changes in the size and the position of the gap 30 in real time. Through this, it is possible to maintain the accurate welding path, minimize a welding defect rate, and secure the consistency of the welding quality by adjusting the laser output and shape in real time.

According to an embodiment of the present disclosure, the battery case welding coordinate correction system may be configured to adjust laser power or a laser shape in real time based on the gap information. Through this, welding conditions are optimized according to gap changes to maintain an accurate welding path, and a defect rate can be minimized by securing consistency of welding quality.

The gap information is a gap between materials on the welding path detected in real time through the coaxial camera 200, and the coaxial camera 200 measures a position and a size of the gap 30 in pixel units to detect changes, and transmits this data to the control board 300. The gap information is a factor directly affecting welding quality, and the laser output and shape are adjusted according to changes in the gap 30.

The laser power adjustment is adjusting an output value of the laser in real time when the gap 30 becomes wider or narrower than a reference value. The control board 300 analyzes the gap information transmitted from the coaxial camera 200, and adjusts the laser power to increase to supply sufficient thermal energy when the gap 30 becomes larger. Conversely, when the gap 30 becomes smaller, the laser power is decreased to prevent excessive heat concentration.

The laser shape adjustment is changing a shape of the laser in real time to maintain constant welding quality. The control board 300 changes the laser shape to a line pattern or a wobble pattern according to an analysis result of the gap information to optimize heat distribution in a welding area. Thereby, welding defects due to imbalance of the gap 30 can be prevented and uniform welding results can be maintained.

The control board 300 transmits a command to the laser oscillator 100 based on the analysis result of the gap information to adjust the output or the shape of the laser. Through real-time data processing and feedback, it is possible to immediately respond to fluctuations of the gap 30 and maintain optimal welding conditions.

As a specific embodiment, in a process of welding a cylindrical battery case 10 and a cap 20, a coaxial high-speed camera detects gap information on a welding path in real time. For example, when a reference value of the gap 30 is set to 0.2 mm, if the gap 30 increases to 0.25 mm in a specific section, the camera detects this and transmits corresponding data to the control board 300. After confirming the increase in the gap 30, the control board 300 commands to increase the laser power in real time so that sufficient thermal energy is supplied.

In addition, when the gap 30 decreases to 0.15 mm, the camera immediately detects this, and the control board 300 decreases the laser power or changes the laser shape to a wobble pattern to disperse heat concentration. This process is repeated in real time, and optimal laser conditions are applied according to fluctuations in the gap 30. Consequently, accurate and uniform welding is performed while minimizing an influence of gap changes on the welding path on welding quality.

As described above, according to an embodiment of the present disclosure, by adjusting the laser power or the laser shape in real time based on the gap information, the gap change of the welding path can be effectively corrected. Through this, the accurate welding path is maintained, consistency of welding quality is secured by preventing excessive or insufficient thermal energy supply, and effects of minimizing a defect rate and improving productivity can be provided by quickly responding to gap imbalance.

According to an embodiment of the present disclosure, the coaxial camera 200 may be configured to analyze a welding shape in real time during welding. Through this, welding shape data generated during welding is monitored and analyzed in real time to maintain consistency of welding quality and an accurate welding path.

The coaxial camera 200 is disposed on the same axis as a laser beam emission path of the laser oscillator 100 to perform a function of detecting and analyzing the welding shape generated during welding in real time.

Here, the welding shape refers to shapes and sizes of a melt pool, which is a molten liquid metal area appearing in a welding part, and a keyhole, which is a deep hole formed by high power of a laser, and may include various aspects appearing on the welding part. The coaxial camera 200 detects change states of the melt pool and the keyhole with high precision in pixel units, and transmits this data to the control board 300.

The melt pool analysis indicates a melting state of the welding part, and directly affects quality and depth of welding. Since an abnormal change in a size or a shape of the melt pool may lead to deterioration of welding quality, it is important to monitor this in real time. The coaxial camera 200 precisely analyzes the size, the shape, and changes of the melt pool and provides data to the control board 300.

The keyhole analysis is detecting the high-temperature hole formed while the laser penetrates a material during welding. Since a depth and a shape of the keyhole determine welding depth and consistency, deformation or abnormality must be detected through real-time analysis. The coaxial camera 200 visually analyzes a state of the keyhole, detects changes, and transmits them to the control board 300.

The control board 300 analyzes welding shape data received from the coaxial camera 200 to monitor a welding state and perform a function of correcting welding conditions if necessary. For example, when the melt pool becomes excessively large, a command such as adjusting laser output or welding speed may be issued.

As a specific embodiment, in a process of laser welding a cylindrical battery case 10 and a cap 20, a coaxial high-speed camera observes the melt pool and the keyhole of the welding part in real time. If the laser output is excessive or insufficient during the welding process, the melt pool may become abnormally large or small. For example, if the melt pool becomes larger than a reference by 20% or more, the camera detects this and transmits corresponding data to the control board 300. The control board 300 immediately adjusts a laser output value or changes a welding speed to return the size of the melt pool to a reference value.

In addition, in the case of the keyhole analysis, when the laser does not deeply penetrate the material or is formed excessively, the coaxial high-speed camera detects a state change of the keyhole and transmits it to the control board 300. The control board 300 analyzes an abnormal state of the keyhole and adjusts the laser output or a scanner speed to maintain the depth and the shape of the keyhole uniformly. This process is repeatedly performed in real time to continuously monitor the welding quality.

As described above, according to an embodiment of the present disclosure, the coaxial camera 200 analyzes the welding shape (e.g., the melt pool and the keyhole) in real time during welding, thereby accurately monitoring the welding state and detecting an abnormal state. Through this, deterioration of welding quality can be prevented, and consistency of the accurate welding path and welding quality can be maintained. In addition, by analyzing changes in the melt pool and the keyhole in real time, process conditions can be optimized to minimize a defect rate and improve productivity.

According to an embodiment of the present disclosure, the battery case welding coordinate correction system may be configured to optimize process conditions in real time based on the analyzed welding shape data. Through this, abnormal welding states occurring during welding are detected, and process conditions such as laser output or welding speed are optimized to maintain an accurate welding path and ensure consistency of welding quality.

The coaxial camera 200 detects and analyzes welding shape data generated during welding in real time. The welding shape includes states of a melt pool and a keyhole, and these two elements have a more significant influence on quality and depth of welding. The coaxial camera 200 analyzes a size, a shape, and heat distribution of the melt pool and a depth and a shape of the keyhole of a welding part, and this data is transmitted to the control board 300.

The control board 300 analyzes the welding shape data transmitted from the coaxial high-speed camera and performs a role of optimizing welding process conditions in real time based thereon. The control board 300 compares the analyzed data with a reference value to optimize laser output, welding speed, a mirror control angle of the scanner, etc. For example, when the melt pool becomes abnormally large, the laser output is decreased, and when the depth of the keyhole is insufficient, the laser output is temporarily increased to maintain uniform welding quality.

Real-time optimization of the process conditions is a function in which the control board 300 immediately adjusts welding conditions according to a welding state. Through this, by immediately responding to changes in the welding shape, a defect rate can be minimized and precision of welding can be maintained.

As a specific embodiment, in a process of welding a cylindrical battery case 10 and a cap 20, the coaxial high-speed camera observes the melt pool and the keyhole in real time during welding and collects data. For example, when the melt pool becomes larger than a reference value and is excessively molten during welding, the camera detects this and transmits data to the control board 300. After analyzing this, the control board 300 commands to decrease a laser output value to adjust the melt pool size to an appropriate level.

In addition, when the depth of the keyhole is insufficient or deformed, the coaxial high-speed camera detects this, and the control board 300 adjusts to normally restore the depth of the keyhole by temporarily increasing the laser output value. Such process optimization is performed in real time during welding, and is repeatedly performed so that the welding state is maintained at the reference value.

Accordingly, according to an embodiment of the present disclosure, by optimizing the process conditions in real time based on the analyzed welding shape data, an abnormal state occurring during welding can be immediately corrected. Through this, the accurate welding path and the consistency of the welding quality are maintained, and changes in the melt pool and the keyhole are adjusted in real time, thereby minimizing the defect rate and improving productivity.

The control board 300 according to an embodiment of the present disclosure serves to calculate coordinates on a welding path based on image data obtained from the coaxial camera 200. It calculates target welding coordinates based on the calculated coordinates, and transmits them to the welding scanner 400 to control a position of a laser beam. The control board 300 compares a current position of the scanner with the target welding coordinates, and performs a correction calculation in real time to maintain an accurate laser position.

The coaxial camera 200 captures the welding path to obtain image data, and the image is converted into coordinate data in pixel units and transmitted to the control board 300.

The control board 300 according to an embodiment of the present disclosure calculates target welding coordinates (X′, Y′) based on two point coordinates (X₁, Y₁) and (X₂, Y₂) received from the coaxial camera 200, and transmits them in real time to correct an error in the welding path. Through this, material thermal deformation, tolerance, and coordinate deviation occurring during welding can be controlled in real time.

According to an embodiment of the present disclosure, the calculated target welding coordinates (X′, Y′) are converted into an encoder value through the signal converter 500, and the control board 300 calculates an error value by comparing a current position of the welding scanner 400 with the target welding coordinates. The calculated error value is used to correct the position of the laser beam in real time through scanner mirror control.

As a specific embodiment, in a process of welding a cylindrical battery case 10 and a cap 20, a coaxial high-speed camera captures a path of a welding part in real time and transmits it to the control board 300. The control board 300 analyzes the received image to recognize two point coordinates (X₁, Y₁) and (X₂, Y₂) on the welding path. For example, the control board 300 calculates the target welding coordinates (X′, Y′) based on a center of the two coordinates or a set offset value.

Thereafter, the control board 300 compares the current position (Encoder X, Encoder Y) of the welding scanner 400 with the target welding coordinates, and controls the welding scanner 400 to correct the laser beam in real time so that it is irradiated to an accurate position. This process is continuously repeatedly performed while welding is in progress, thereby minimizing errors in the welding path.

As described above, the control board 300 precisely analyzes the image obtained from the coaxial high-speed camera and calculates coordinates, thereby deriving the target welding coordinates more accurately. Through this, the position of the laser beam is corrected in real time to increase accuracy of the welding path. In addition, an effect of maintaining consistency and precision of welding quality is provided by minimizing welding errors caused by thermal deformation or tolerance of the material.

According to an embodiment of the present disclosure, the control board 300 may be configured to calculate a correction value of the laser beam by comparing a current position of the welding scanner 400 with target welding coordinates. Through this, position errors of the welding scanner 400 are detected and corrected in real time to increase position accuracy of the laser beam, thereby maintaining a precise welding path and securing consistency of welding quality.

The control board 300 calculates the target welding coordinates based on two point coordinates (X₁, Y₁) and (X₂, Y₂) received through the coaxial camera 200, and collects the current position of the welding scanner 400 in real time through an encoder value. Based on this data, the control board 300 compares a difference between the two values, calculates this as a correction value, and transmits it to the welding scanner 400.

The target welding coordinates are final target coordinates calculated by the control board 300 from the two point coordinates received through the coaxial camera 200, and indicate a position where the laser beam should move along the welding path. When the target welding coordinates are generated based on a center value or a set offset value of the two point coordinates, the control board 300 corrects the current position of the welding scanner 400 based on this value.

The current position of the welding scanner 400 is coordinates where the welding scanner 400 is currently positioning the laser beam, and is provided as an encoder value measured in real time through the signal converter 500. The encoder value is used as a reference value that the control board 300 compares with the target welding coordinates.

The correction value is a result value obtained by the control board 300 calculating a difference between the target welding coordinates and the current position, and the correction value is used to adjust the position of the laser beam by controlling a mirror of the welding scanner 400.

As a specific embodiment, in a process of welding between a cylindrical battery case 10 and a cap 20, the control board 300 compares the target welding coordinates with the current position of the welding scanner 400 provided in real time as the encoder value through the signal converter 500 to detect a difference between the current position and the target welding coordinates. For example, when the target welding coordinates are X′, Y′ and the current position is X, Y, the correction value is calculated as |X′−X| and |Y′−Y|.

The correction value is transmitted to the welding scanner 400 to correct the position of the laser beam to match the target welding coordinates by controlling the scanner mirror. If a change occurs in the welding path due to thermal deformation or fluctuation of the gap 30, the control board 300 detects this error in real time and repeatedly calculates the correction value so that the welding scanner 400 continuously follows an accurate path.

As described above, according to an embodiment of the present disclosure, the control board 300 calculates the correction value by comparing the target welding coordinates with the current position of the welding scanner 400, thereby correcting the error of the welding path in real time. Through this, position accuracy of the laser beam is maintained, and welding defects due to thermal deformation or errors are minimized.

According to an embodiment of the present disclosure, the control board 300 may be configured to analyze a coordinate change caused by at least one of thermal deformation of a material, positional misalignment of the material, a tolerance, and a gap deviation, and correct this in real time. Through this, precision of a welding path and consistency of welding quality may be maintained, and an influence of external factors that may occur during a welding process may be minimized.

The control board 300 analyzes the coordinate change and calculates a correction value based on data obtained from the coaxial camera 200. The coaxial camera 200 captures a real-time image of the welding path and transmits the coordinate change due to deformation or positional misalignment of the material to the control board 300.

The thermal deformation occurs as thermal energy of a laser causes local expansion or contraction of the material during welding. The control board 300 analyzes such thermal deformation data and modifies target coordinates in real time.

The positional misalignment of the material appears when placement of the material is not accurate or movement occurs during assembly, and causes a change in the welding path. The control board 300 resets welding coordinates based on this data.

The tolerance is a minute dimensional difference occurring in a manufacturing process of the material, and directly affects the welding quality. The control board 300 analyzes this and adjusts coordinates so that uniform welding is performed.

The gap deviation refers to a change in an interval between two materials on the welding path, and the control board 300 uses this deviation data to adjust laser output or a path.

The control board 300 according to an embodiment of the present disclosure processes the data in real time to generate a correction value, and transmits it to a scanner mirror to control a position of a laser beam to match the target coordinates.

As a specific embodiment, in a process of welding a cylindrical battery case 10 and an upper cap 20, a coaxial high-speed camera recognizes a position of the material and two point coordinates on the welding path in real time. For example, when the material expands due to heat of a high-temperature laser or a position is shifted due to an assembly error, the coaxial high-speed camera provides such a change as data. The control board 300 calculates a difference between target welding coordinates (X′, Y′) and current welding coordinates based on corresponding data. A correction value is generated based on the calculated difference, and the correction value is used to adjust a reflection angle of the laser beam through the scanner mirror. This process continuously corrects coordinate changes caused by various causes such as a tolerance and a gap deviation occurring during welding.

As described above, according to an embodiment of the present disclosure, by the control board 300 analyzing coordinate changes occurring during welding and correcting them in real time, errors due to thermal deformation of the material, positional misalignment, tolerance, and gap deviation can be effectively corrected. Through this, it is possible to maintain an accurate welding path and secure consistency of welding quality.

According to an embodiment of the present disclosure, the control board 300 may be configured to correct the coordinate change in real time by controlling a scanner mirror to maintain constant welding quality. The control board 300 detects and analyzes the coordinate change occurring in a welding path, and modifies a position of a laser beam through the scanner mirror so that target welding coordinates can be accurately followed. Through this, precision of the welding path and consistency of welding quality may be maintained.

The control board 300 performs a role of analyzing the coordinate change in real time, calculating a correction value, and controlling the scanner mirror. The coordinate change occurs due to various causes such as thermal deformation of a material, positional misalignment, tolerance, and gap deviation, and the control board 300 detects this and quickly generates the correction value. The control board 300 calculates a difference between the target welding coordinates and an actual welding path based on data received from the coaxial camera 200.

The scanner mirror is a component included in the welding scanner 400, and adjusts a reflection angle of the laser beam based on the correction value calculated by the control board 300 to match actual coordinates to the target welding coordinates. Through real-time interworking between the control board 300 and the scanner mirror, the position of the laser beam is immediately modified even if the coordinate change occurs. This allows stable welding quality to be maintained even in situations where the welding path is complex or fluctuations are large.

As a specific embodiment, in a welding process of a cylindrical battery case 10 and an upper cap 20, the material may be deformed by laser heat or positional misalignment may occur due to an assembly error. At this time, a coaxial high-speed camera detects the welding path in real time, and transmits the coordinate change caused by the thermal deformation of the material or the positional misalignment to the control board 300 as data. The control board 300 analyzes a difference between target welding coordinates (X′, Y′) and a current welding path based on this data, and calculates a correction value for controlling the scanner mirror. The scanner mirror adjusts the reflection angle of the laser beam according to a control signal so that the laser beam is irradiated to the modified target welding coordinates. Such correction may be performed continuously while welding is in progress.

As described above, according to an embodiment of the present disclosure, by correcting the coordinate change in real time through interaction between the control board 300 and the scanner mirror, errors in the welding path can be minimized and precise welding quality can be consistently maintained. In particular, it is possible to immediately respond to coordinate changes occurring due to external factors or complex welding paths, and effectively correct influences such as thermal deformation, tolerance, positional misalignment, and gap deviation. Thereby, stability and productivity of the welding process are simultaneously improved, and high-quality consistent welding results can be provided.

The welding scanner 400 according to an embodiment of the present disclosure performs a role of correcting a position of a laser beam in real time according to target welding coordinates received from the control board 300. The welding scanner 400 adjusts a reflection angle and a direction of the laser beam using a scanner mirror to maintain precision of a welding path, and performs a role of immediately correcting coordinate changes occurring due to various variables such as thermal deformation, positional misalignment, tolerance, and gap deviation.

The welding scanner 400 may be composed of a scanner mirror and a driving mechanism for controlling the same. The scanner mirror is a component that adjusts the reflection angle of the laser beam in real time, and operates based on a correction signal generated by the control board 300.

The control board 300 analyzes data obtained from the coaxial camera 200 to calculate the target welding coordinates, and calculates a difference between current welding coordinates and the target welding coordinates to generate a correction value. This correction value is transmitted to the welding scanner 400, and the welding scanner 400 controls the scanner mirror based on this to adjust the position of the laser beam. This process is continuously repeated during welding, and responds to coordinate changes in real time.

Specifically, in a process of welding a cylindrical battery case 10 and an upper cap 20, a case may occur where the welding path changes differently from expectation due to thermal deformation of a material or assembly misalignment. At this time, a coaxial high-speed camera detects changed path data in real time and transmits it to the control board 300. The control board 300 analyzes a difference between target coordinates and the current welding coordinates, calculates a correction value, and transmits it to the welding scanner 400. The welding scanner 400 adjusts the scanner mirror to match the position of the laser beam to the modified target coordinates. This operation is performed repeatedly throughout the welding process, and maintains an accurate welding path even if coordinate changes occur.

As described above, the welding scanner 400 according to an embodiment of the present disclosure controls the position of the laser beam in real time through interworking with the control board 300, thereby effectively correcting coordinate errors caused by external factors such as thermal deformation, positional misalignment, tolerance, and gap deviation. Through this, precision of the welding path can be increased, and stable and consistent quality can be maintained even in complex welding operations.

The signal converter 500 (e.g., an embedded pulse generator) according to an embodiment of the present disclosure performs a role of converting target welding coordinates into an encoder value and providing it to the control board 300. This is converting coordinate data into a signal form usable in the welding scanner 400.

The signal converter 500 converts the target welding coordinates calculated from the control board 300 into an encoder value and provides it back to the control board 300, thereby enabling real-time control of a welding process. That is, it converts the target welding coordinates into an encoder signal to enable interworking with the welding scanner 400, and simultaneously feeds back current position data of a scanner mirror to the control board 300 as an encoder value.

First, the signal converter 500 converts target welding coordinate data received from the control board 300 into an encoder value. This encoder value is a signal necessary for controlling the scanner mirror in the welding scanner 400, and is used to adjust a position of a laser beam in real time.

In addition, the signal converter 500 measures a current position of the scanner mirror, converts it into a current encoder value, and transmits it to the control board 300. This feedback data is utilized by the control board 300 to calculate a difference between the target welding coordinates and an actual laser beam position and calculate an additional correction value.

The signal converter 500 performs such data transmission and conversion in real time to support smooth interworking between the control board 300 and the welding scanner 400, and enables precise control of the welding path.

As a specific embodiment, in a process of welding a cylindrical battery case 10 and an upper cap 20, the control board 300 calculates target welding coordinates (X′, Y′) based on data obtained from a coaxial high-speed camera. The signal converter (e.g., an embedded pulse generator) 500 converts these target welding coordinates into an encoder value and transmits it to the welding scanner 400.

For example, if the target coordinates are X′=10.5, Y′=15.7, the signal converter 500 converts them into an encoder signal and transmits it as a driving signal for the scanner mirror. At the same time, it measures the current position of the scanner mirror to generate a current encoder value, and transmits it to the control board 300. The control board 300 uses this data to calculate a difference between the current position and a target position, and generates a correction value for additional correction.

This process is continuously repeated while welding is in progress, and immediately responds to changes in the welding path so that the laser beam accurately follows the target coordinates.

Accordingly, according to an embodiment of the present disclosure, the signal converter 500 converts the target welding coordinates into an encoder value and feeds back current position data to the control board 300, thereby allowing components of the system to be synchronized. Through this, errors in the welding path are minimized, and correction operations can be performed in real time.

As described above, the battery case welding coordinate correction system according to the present disclosure is applied to a process of welding a gap 30 between a battery case 10 and a cap 20. First, the laser oscillator 100 outputs a laser beam, and the coaxial camera 200 captures a welding path in real time on the same axis. The control board 300 analyzes an image obtained from the coaxial camera 200 to calculate coordinates of the welding path, and calculates target welding coordinates based on this. The signal converter 500 converts the calculated target welding coordinates into an encoder value and provides it to the control board 300, and the control board 300 transmits a correction value to the welding scanner 400. The welding scanner 400 performs welding while correcting a position of the laser beam to match the target welding coordinates in real time. As this process is repeated, welding can be completed more accurately.

Accordingly, the battery case welding coordinate correction system according to the present disclosure can effectively correct thermal deformation, gap deviation, material error, etc. occurring during welding by correcting the position of the laser beam in real time based on the target welding coordinates. Through this, accuracy of the welding path is maintained, and welding quality can be consistently secured. In addition, high-speed and precision welding become possible through real-time control, providing effects of productivity improvement and defect rate reduction.

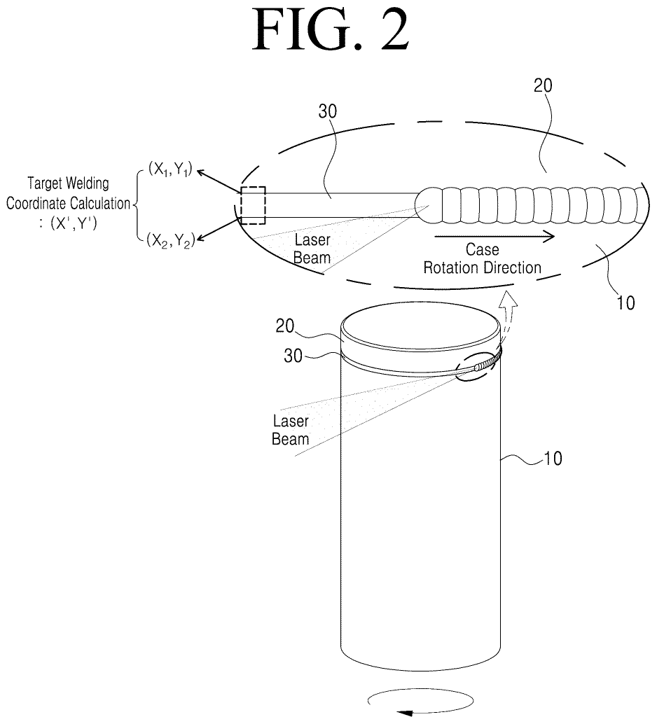

FIG. 2 is a schematic diagram showing a welding operation process of a battery case welding coordinate correction system according to an embodiment of the present disclosure, showing a process in which a laser beam moves along a welding path and proceeds with welding together with a rotation direction (arrow) of a cylindrical battery case 10. The laser beam output from the laser oscillator 100 is irradiated onto a surface of the cylindrical battery case 10, and welding proceeds through this.

In FIG. 2, two point coordinates (X1, Y1) and (X2, Y₂) of the welding path are shown, and based on these, target welding coordinates (X′, Y′) are calculated.

In addition, according to an embodiment of the present disclosure, the coaxial camera 200 is disposed to perform a process of capturing the welding path in real time on the same axis as a laser beam emission path and recognizing the two point coordinates through the obtained image. This data is transmitted to the control board 300 to calculate the target welding coordinates, and the calculated target welding coordinates are converted into an encoder value through the signal converter (e.g., an embedded pulse generator) 500. This information is sent to the welding scanner 400 to control a scanner mirror to correct the position of the laser beam in real time.

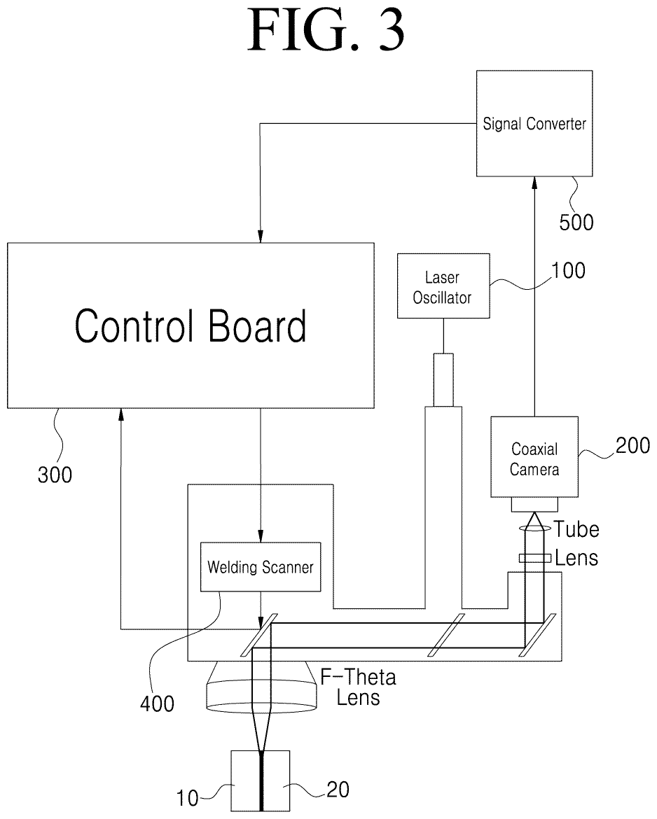

FIG. 3 illustrates a schematic configuration diagram and signal flow of a battery case welding coordinate correction system according to an embodiment of the present disclosure.

The battery case welding coordinate correction system according to an embodiment of the present disclosure includes a coaxial camera 200, a control board 300, an embedded pulse generator, a welding scanner 400, and a laser oscillator 100, wherein these components interact with each other to maintain precision of a welding operation through real-time coordinate correction.

As illustrated, the coaxial camera 200 is disposed such that a field of view (FOV) matches a path of a laser beam, captures an image of a welding path in real time, and generates pixel data based thereon. The generated data is transmitted to the control board 300, and the control board 300 calculates current welding coordinates using this and performs a comparison with target welding coordinates.

The control board 300 communicates with the embedded pulse generator to calculate the target welding coordinates and convert them into an encoder value, and the embedded pulse generator generates the encoder value based on the calculated coordinates and transmits it back to the control board 300. Using this data, the control board 300 controls the welding scanner 400 and adjusts a mirror of the scanner to correct a position of the laser beam in real time.

As illustrated, a Tube Lens is for focusing the laser beam or optical signal reflected from the welding path and transmitting it to the coaxial camera 200 without distortion, and the welding scanner 400 transmits the laser beam to a surface of a battery case 10 more accurately through an F-Theta Lens, and continuously adjusts the position of the laser beam based on data transmitted from the control board 300. This process may be repeatedly performed to maintain constant welding quality.

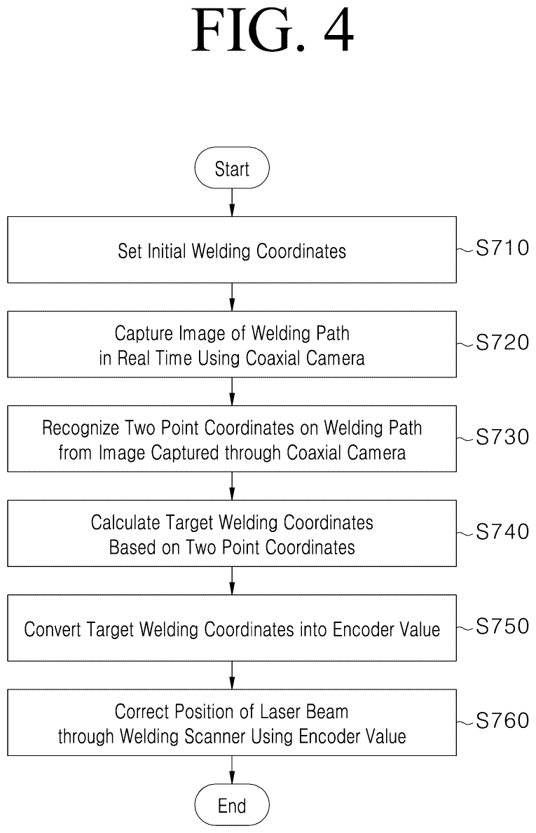

FIG. 4 is a flowchart explaining a battery case welding coordinate correction method according to an embodiment of the present disclosure. In the battery case welding coordinate correction method according to an embodiment of the present disclosure, descriptions of parts overlapping with the above-described welding coordinate correction system will be omitted.

As illustrated in FIG. 4, the battery case welding coordinate correction method according to an embodiment of the present disclosure includes setting initial welding coordinates (S710), capturing an image of a welding path in real time using a coaxial camera (S720), recognizing two point coordinates on the welding path from the image captured through the coaxial camera (S730), calculating target welding coordinates based on the two point coordinates (S740), converting the target welding coordinates into an encoder value (S750) and correcting a position of a laser beam through a welding scanner using the encoder value (S760), and the method may repeat steps starting from the step of capturing the image of the welding path while welding is in progress.

In the battery case welding coordinate correction method according to an embodiment of the present disclosure, first, initial welding coordinates are set (S710). This is for designating a starting position of a laser beam for a battery case which is a work target.

The control board receives initial setting values, and they are generally designated in a form of “Command X” and “Command Y”. These initial welding coordinates may be input in advance by an operator or automatically calculated and set by a system.

The set initial welding coordinates serve as a reference point for the laser oscillator and the coaxial camera, and may be utilized as basic data for subsequent welding path calculation and correction.

In addition, the battery case welding coordinate correction method according to an embodiment of the present disclosure captures an image of a welding path in real time using the coaxial camera (S720).

This is a process of continuously detecting a state of a material and the welding path, wherein the coaxial camera provides a high-resolution image to record a current state of the welding path, and may detect deformation or deviation in real time.

In addition, the battery case welding coordinate correction method according to an embodiment of the present disclosure recognizes two point coordinates on the welding path from the captured image (S730).

This is a process of deriving the two point coordinates on the welding path by analyzing the image obtained by the coaxial camera, wherein the coordinates are expressed in pixel units, and target welding coordinates are calculated therefrom.

The two point coordinates on the welding path according to an embodiment of the present disclosure may be recognized in pixel units.

The coaxial camera captures the welding path in real time to generate a high-resolution image, and may recognize the two point coordinates on the welding path in pixel units. By recognizing coordinates in pixel units, even small deformation or gap deviation of the welding path can be detected more accurately.

Here, in a pixel-unit coordinate recognition process, the coaxial camera obtains the image of the welding path in real time, and the captured image is processed in pixel units. In this process, the two point coordinates of the welding path are derived as specific pixel positions, and this data is transmitted to the control board. The control board calculates the target welding coordinates based on pixel data, and converts them into an encoder value through a signal converter. The coordinate recognition in pixel units increases resolution of data to enable precise welding path correction.

In addition, the battery case welding coordinate correction method according to an embodiment of the present disclosure calculates the target welding coordinates based on the two point coordinates (S740).

This is performed in the control board, wherein the control board calculates target welding coordinates (X′, Y′) based on the two point coordinates, and derives a calculation result based on a center value on the welding path or a set offset value.

According to an embodiment of the present disclosure, the target welding coordinates may be calculated by applying a center value or a set offset value based on the two point coordinates.

The coaxial camera captures the welding path in real time, and derives the two point coordinates on the welding path through image analysis. The control board calculates the target welding coordinates based on the two point coordinates received from the coaxial camera. In this process, the target welding coordinates are determined based on the center value of the two point coordinates or the set offset value.

The center value-based calculation is calculating a median of the two point coordinates and setting it as the target welding coordinates, which is used in a symmetrical welding path, and optimizes welding quality while maintaining left-right balance.

The offset value-based calculation is setting a value shifted by a specific distance from the center value of the two point coordinates as the target welding coordinates to respond to specific process requirements or an asymmetrical welding path, which may be flexibly adjusted according to characteristics of a material or welding conditions.

Through this, precision of the welding path and consistency of welding quality are maintained, and high reliability and productivity may be secured even under various material and process conditions.

According to an embodiment of the present disclosure, the step of calculating the target welding coordinates may include analyzing gap information of a material and additionally reflecting a combined analysis result of the analyzed gap information and welding shape data.

This relates to a method of improving precision of a welding path and securing consistency of welding quality by performing a combined analysis of the gap information of the material and the welding shape data in the process of calculating the target welding coordinates.

The coaxial camera captures a state of the material and the welding path in real time to generate an image including the gap information indicating an interval between materials and the welding shape data. The gap information is data obtained by analyzing a physical interval between materials in pixel units, and the welding shape data indicates a size of a melt pool, a shape of a keyhole, a laser irradiation state, etc.

The control board performs a combined analysis of the gap information and the welding shape data received from the coaxial camera to calculate the target welding coordinates on the welding path. In this process, the gap information reflects a change in the interval of the welding path, and the welding shape data is used to evaluate stability and quality of a welding state. The control board processes this data comprehensively to provide criteria necessary when setting the target welding coordinates.

By performing the combined analysis of the gap information and the welding shape data as described above, it is possible to respond to complex changes on the welding path in real time. For example, if the gap information is larger or smaller than a reference value, the control board may additionally analyze the welding shape data to adjust a position of a laser beam or change output conditions.

Through this, consistency of welding quality is maintained, and errors that may occur depending on physical characteristics of the material or welding conditions can be minimized. In particular, even if a gap deviation and a welding shape change occur due to a complex welding path or external factors, they can be effectively corrected.

In addition, the battery case welding coordinate correction method according to an embodiment of the present disclosure converts the target welding coordinates into an encoder value (S750). This is performed through the signal converter, and in this process, target welding coordinate data is converted into an encoder value that the welding scanner can understand.

In addition, the battery case welding coordinate correction method according to an embodiment of the present disclosure corrects a position of the laser beam through the welding scanner using the encoder value (S760). This is a process in which the welding scanner modifies the position of the laser beam based on a corrected signal, and the welding scanner adjusts a scanner mirror to move the laser beam to the target welding coordinates.

The correcting step according to an embodiment of the present disclosure includes a process of calculating a difference between the target welding coordinates and a current position of the welding scanner and correcting the position of the laser beam in real time, and the correction may be repeatedly performed while welding is in progress. This is continuously repeatedly performed during welding to maintain a precise welding path, thereby securing stability and consistency of welding quality.

The control board calculates the target welding coordinates based on data received from the coaxial camera, and continuously monitors a current position of the scanner mirror to collect current welding coordinate data. The control board calculates a difference between the target coordinates and the current welding coordinates, converts it into a correction value, and transmits it to the welding scanner.

The welding scanner uses the correction value received from the control board to control the scanner mirror and modifies the position of the laser beam. In this process, the correction value is set in a direction that minimizes the difference between the current welding coordinates and the target coordinates. For example, if the position of the laser beam is biased to the right of the target welding coordinates, the correction value is calculated to move the laser beam to the left.

This minimizes errors in the welding path through a method of calculating and correcting the difference between the target welding coordinates and the current position in real time, and maintains precision and consistency of welding quality.

In addition, by repeatedly performing the correction process, coordinate changes caused by thermal deformation, tolerance, gap deviation, positional misalignment, etc. can be immediately modified. Through this, high precision is provided even in a complex welding path, and stability and productivity of a process can be improved.

According to an embodiment of the present disclosure, the difference value may include a process of being calculated based on encoder values of the target welding coordinates and the current position. This is correcting changes in a welding path in real time by calculating the difference value between the target welding coordinates and the current position based on the encoder values. The encoder value is data enabling precise position control of the welding scanner, and by utilizing this to calculate the difference value, errors in the welding path can be minimized and accurate welding quality can be maintained.

The signal converter 500 (e.g., an embedded pulse generator) generates pulses to convert the target welding coordinates received from the control board 300 into an encoder value, and generates current position data of the welding scanner 400 as an encoder value. Through this, both the target welding coordinates and current welding coordinates are expressed as encoder values, and the control board 300 can calculate a difference between the two values.

The control board 300 calculates the difference value between the target welding coordinates and the current welding coordinates as |X′−X| and |Y′−Y|. In this process, the encoder value converts coordinate data into a precise digital format, provided as a signal to which the welding scanner 400 can immediately respond.

The welding scanner 400 modifies a position of a laser beam by adjusting a scanner mirror based on the difference value received from the control board 300. This process is repeatedly performed while welding is in progress, so that correction is made whenever a change in the path occurs.

This enables precise processing of coordinate data and real-time correction by calculating the difference value between the target welding coordinates and the current position based on the encoder values. Through this, errors in the welding path are minimized, and it is possible to respond to various variables such as thermal deformation of a material, positional misalignment, tolerance, and gap deviation.

According to an embodiment of the present disclosure, the method may further include a step of obtaining welding shape data during welding using the coaxial camera 200 and feeding back process conditions during or after the step of correcting the position of the laser beam. This secures both precision and stability of welding quality by analyzing shape data in real time during welding and immediately adjusting process conditions such as laser power, shape, and welding path.

The coaxial camera 200 captures welding shapes such as a melt pool and a keyhole in real time during welding, and transmits them to the control board 300. The control board 300 analyzes the data transmitted from the coaxial camera 200 to detect an abnormal state occurring in the welding shape, for example, a case where a size of the keyhole is smaller than a reference or the melt pool is uneven, and generates a feedback signal for adjusting process conditions. The process conditions include major variables such as laser power, shape, and a position of the welding path, and the control board 300 performs feedback in real time to optimize them.

The laser oscillator 100 and the welding scanner 400 receive the feedback signal from the control board 300 to adjust output intensity and irradiation shape of the laser. Such adjustment reflects changes in the welding path and optimizes a process so that welding quality can be maintained constantly.

Specifically, in a process of welding a cylindrical battery case 10 and an upper cap 20, a coaxial high-speed camera captures the melt pool and the keyhole of the welding path in real time. For example, if the melt pool expands excessively or the keyhole size shrinks, this may indicate that the laser power is excessive or insufficient.

The control board 300 analyzes this data and transmits a signal to decrease output or a signal to increase output intensity to the laser oscillator 100. Also, if the keyhole deviates from a reference position, the position of the laser beam may be readjusted by controlling the scanner mirror. This process is performed repeatedly and continuously while welding is in progress, maintaining stability of the process.

According to an embodiment of the present disclosure, feeding back the process conditions may adjust laser power or a laser shape according to an analysis result of the welding shape.

This analyzes the welding shape in real time during welding, and sets optimal laser conditions based on this to enable response to various process conditions.

The coaxial camera 200 captures and analyzes the welding shape in real time during welding. That is, it detects interactions between the laser and a material such as a melt pool and a keyhole with high resolution to record changes in the welding shape.

The control board 300 analyzes the welding shape data received from the coaxial camera 200. In this analysis process, it detects an abnormal state of the welding shape, for example, a case where a keyhole size is smaller than a reference or a melt pool is uneven. Based on this data, the control board 300 generates a feedback signal for adjusting the laser power or the shape. The laser power affects welding depth and quality, and the shape (e.g., a line or wobble shape) plays an important role in securing uniformity of the welding path.

The laser oscillator 100 adjusts output intensity or changes an irradiation shape of the laser according to the feedback signal received from the control board 300. Such adjustment provides conditions optimized for the welding path and material state in real time, and enables welding of constant quality even if deformation or deviation occurs.

As described above, according to an embodiment of the present disclosure, stability and precision of welding quality are maintained by adjusting the laser power or the shape in real time according to the analysis result of the welding shape. For example, the laser power adjustment optimizes the welding depth, and the laser shape adjustment secures uniformity of the welding path. Through this, changes according to characteristics of the material and the welding path are quickly reflected, and quality deterioration due to thermal deformation, gap deviation, tolerance, etc. is prevented.

Finally, according to an embodiment of the present disclosure, the method may repeat steps starting from the step of capturing the image of the welding path while welding is in progress. This is a process of continuously responding to changes in the welding path, updating data in real time, and repeatedly performing correction, so that precision and consistency of the welding path are maintained.

As described above, in the battery case welding coordinate correction method according to an embodiment of the present disclosure, in a process of welding a cylindrical battery case 10 and an upper cap 20, a coaxial camera 200 captures an image of a welding path in real time after setting initial welding coordinates. Two point coordinates on the welding path are derived from the captured image, and based on this, target welding coordinates are calculated in a control board 300.

A signal converter 500 converts the calculated target coordinates into an encoder value and transmits it to a welding scanner 400, and the welding scanner 400 adjusts a scanner mirror to accurately irradiate a laser beam to the modified target welding coordinates. This process is continuously repeatedly performed while welding is in progress, and it is possible to respond in real time to coordinate changes due to thermal deformation or gap deviation of the material.

Accordingly, the battery case welding coordinate correction method according to the present disclosure maintains precision of the welding path and consistency of welding quality by analyzing and correcting coordinate changes occurring due to various factors such as thermal deformation, positional misalignment, tolerance, and gap deviation occurring in a welding process in real time. In particular, it is possible to quickly respond to all coordinate changes occurring during welding through repetitive performance, thereby ensuring high precision even in a complex welding path and significantly improving stability of the process.

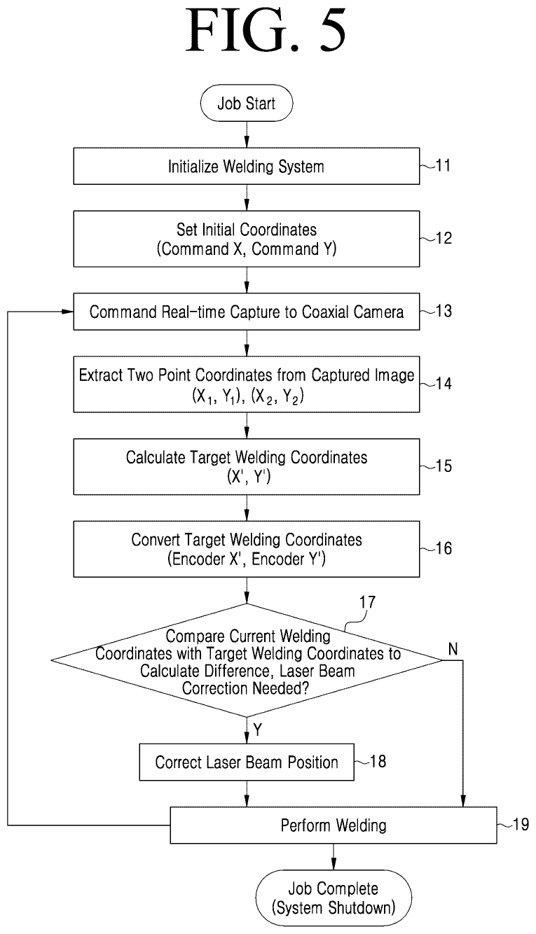

FIG. 5 illustrates a workflow for a battery case welding coordinate correction system according to an embodiment of the present disclosure.

Job Start: The system is powered on and a welding operation is prepared. When a start signal for the operation is given, subsequent steps are performed sequentially.

Initialize Welding System (11): Initial settings and preparation work of the system are performed. Initial conditions required for welding are set, and all devices are switched to a normal operation ready state.

Set Initial Coordinates (12): Command X and Command Y values are set to define initial welding coordinates. These coordinates indicate a starting point of the operation and are stored by the control board.

Command Real-time Capture to Coaxial Camera (13): The coaxial camera is activated, and a command to capture an image of a welding path in real time is executed. The coaxial camera performs a role of accurately recognizing a position and a state of a welding target.

Extract Two Point Coordinates from Captured Image (14): Two point coordinates (X₁, Y₁) and (X₂, Y₂) representing the welding path are extracted from the image captured by the coaxial camera. These coordinates are utilized as basic data for calculating a target welding position.

Calculate Target Welding Coordinates (15): The control board calculates target welding coordinates (X′, Y′) according to a center coordinate or a set criterion based on the extracted two point coordinates. These coordinates define an accurate position of a welding operation to be performed by the welding scanner.

Convert Target Welding Coordinates (16): The calculated target welding coordinates (X′, Y′) are converted into encoder values (Encoder X′, Encoder Y′). This is transmitted in real time through signal linkage between the welding scanner and the control board.

Compare Current Welding Coordinates with Target Welding Coordinates (17): Current welding coordinates and the target welding coordinates are compared by the control board. In this process, a difference value between the coordinates is calculated, and it is determined whether laser beam position correction is needed.

Correct Laser Beam Position (18): When the laser beam position correction is needed, the control board corrects the laser beam position through the welding scanner. This is performed in real time based on the calculated difference value, increasing welding accuracy.

Perform Welding (19): A welding operation proceeds using the corrected laser beam. In this step, the welding process is continuously monitored so that welding quality is maintained.

Repeated Performance: The above steps are repeated until welding is completed along a target welding path. This repetition process is adjusted according to a shape and a size of the welding target.

Job Complete (System Shutdown): When all welding operations are completed, the system is shut down. Operation data is stored or recorded, and the system is switched to a stop state.

As illustrated, according to an embodiment of the present disclosure, welding quality can be maintained and efficiency can be increased through repetitive performance of operations and real-time correction.

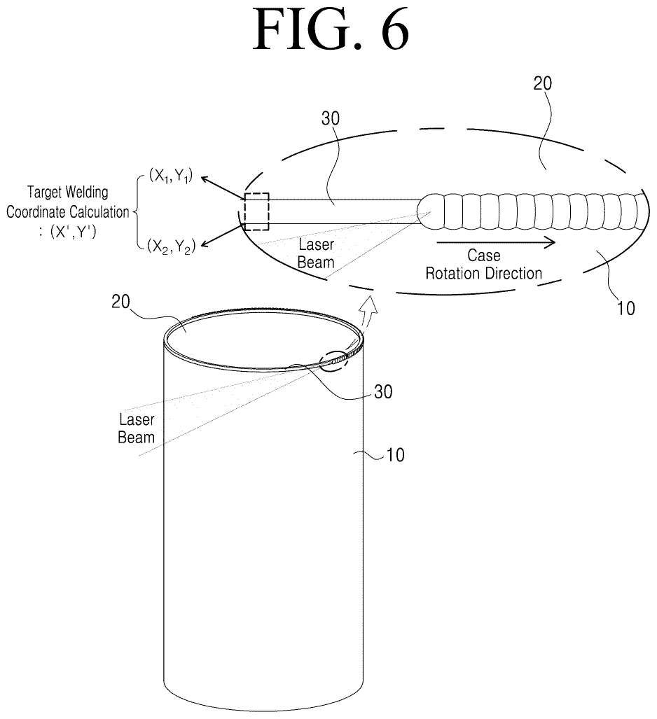

FIG. 6 is a schematic diagram showing a welding operation process of a battery case welding coordinate correction system according to another embodiment of the present disclosure, intended to weld a gap 30 between a cylindrical battery case 10 and an upper cap 20.

FIG. 6 shows a process in which a laser beam moves along a welding path together with a rotation direction of the battery case 10 and proceeds with welding, indicating that it is applicable even when a welding shape is circular between the upper cap 20 and the battery case 10.

This indicates that, according to an embodiment of the present disclosure, correction for the welding path is possible through coordinate recognition as long as any welding path, not just a circular one, enters a field of view (FOV) of a coaxial camera 200 and capturing of the welding path is possible.

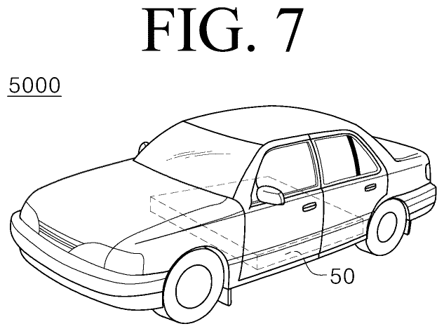

FIG. 7 illustrates an electric vehicle 5000 receiving power required for driving an electric motor from a battery pack 50 including a battery cell or a battery module welded by a battery case welding coordinate correction system and a method thereof according to an embodiment of the present disclosure.

Accordingly, the electric vehicle 5000 uses a battery with improved welding quality, thereby contributing to stabilization of battery performance.

Meanwhile, the electric vehicle 5000 according to an embodiment of the present disclosure may further include a control system (e.g., Electronic Control Unit (ECU)) communicating with a battery management system via a designated communication method (e.g., Control Area Network (CAN)), and at least one display providing (e.g., displaying) various information of the electric vehicle 5000 (e.g., state information of the battery pack or cells included in the battery pack, welding state information of the battery cell according to the present disclosure, driving information of the electric vehicle 5000, etc.).

In addition, the present disclosure may be applied to various devices operating by receiving power from the battery cell, the battery module, or the battery pack 50 with improved welding quality by applying the battery case welding coordinate correction system and method according to an embodiment of the present disclosure. For example, it may be applied to an electric mobility device (e.g., a hybrid vehicle, an electric bicycle, an electric motorcycle, etc.), an Energy Storage System (ESS), etc.

Various embodiments of the present disclosure may be implemented as software (e.g., a program) including one or more instructions stored in a storage medium (e.g., an internal memory or an external memory) readable by a machine (e.g., an electronic device).

For example, a processor of the machine (e.g., an electronic device) may call at least one instruction among the one or more instructions stored from the storage medium and execute it. This makes it possible for the machine to be operated to perform at least one function according to the called at least one instruction. The one or more instructions may include code generated by a compiler or code executable by an interpreter. The storage medium readable by the machine may be provided in a form of a non-transitory storage medium. Here, ‘non-transitory’ only means that the storage medium is a tangible device and does not include a signal (e.g., electromagnetic waves), and this term does not distinguish between cases where data is semi-permanently stored and cases where data is temporarily stored.

The method according to various embodiments of the present disclosure may be provided included in a computer program product. The computer program product may be traded between a seller and a buyer as a product. The computer program product may be distributed in a form of a storage medium readable by a machine (e.g., compact disc read only memory (CD-ROM)) or distributed online (e.g., downloaded or uploaded) through an application store (e.g., Play Store™) (or directly between two user devices (e.g., smart phones)). In the case of online distribution, at least a part of the computer program product may be at least temporarily stored or temporarily generated in a storage medium readable by a machine such as a memory of a server of a manufacturer, a server of an application store, or a relay server.

The contents described above are merely examples applying the principles of the present disclosure, and other configurations may be further included without departing from the scope of the present invention. For example, at least some of the various embodiments of the present disclosure described above may be combined.

What is claimed is:

1. A battery case welding coordinate correction system, comprising:
a laser oscillator configured to output a laser beam;
a coaxial camera disposed on a same axis as an emission path of the laser beam of the laser oscillator;
a control board configured to calculate coordinates on a welding path based on an image obtained from the coaxial camera;
a welding scanner configured to correct a position of the laser beam in real time according to target welding coordinates received from the control board; and
a signal converter configured to convert the target welding coordinates into an encoder value and provide the encoder value to the control board.

2. The system of claim 1, wherein the coaxial camera is configured to recognize two point coordinates on the welding path in pixel units.

3. The system of claim 2, wherein the control board is configured to calculate the target welding coordinates by applying a center value or a set offset value based on the two point coordinates.

4. The system of claim 1, wherein the coaxial camera is configured to analyze gap information of the welding path.

5. The system of claim 4, wherein the control board is configured to adjust laser power or a laser shape in real time based on the gap information.

6. The system of claim 1, wherein the coaxial camera is configured to analyze a welding shape in real time during welding.

7. The system of claim 6, wherein the control board is configured to optimize process conditions in real time based data on the analyzed welding shape.

8. The system of claim 1, wherein the control board is configured to calculate a correction value of the laser beam by comparing a current position of the welding scanner with the target welding coordinates.

9. The system of claim 1, wherein the control board is configured to analyze a coordinate change caused by at least one of thermal deformation of a material, positional misalignment of the material, a tolerance, and a gap deviation, and correct the coordinate change in real time.

10. The system of claim 9, wherein the control board is configured to correct the coordinate change in real time by controlling a scanner mirror of the welding scanner to maintain constant welding quality.

11. A battery case welding coordinate correction method, comprising:
setting initial welding coordinates;
capturing an image of a welding path in real time using a coaxial camera;
recognizing two point coordinates on the welding path from the image captured through the coaxial camera;
calculating target welding coordinates based on the two point coordinates;
converting the target welding coordinates into an encoder value; and
correcting a position of a laser beam through a welding scanner using the encoder value,
wherein the method repeats steps starting from the step of capturing the image of the welding path while welding is in progress.

12. The method of claim 11, wherein the two point coordinates on the welding path are recognized in pixel units.

13. The method of claim 12, wherein the target welding coordinates are calculated by applying a center value or a set offset value based on the two point coordinates.

14. The method of claim 11, wherein calculating the target welding coordinates comprises analyzing gap information of a material and additionally reflecting a combined analysis result of the analyzed gap information and welding shape data.

15. The method of claim 11, wherein correcting the position of the laser beam comprises calculating a difference between the target welding coordinates and a current position of the welding scanner and correcting the position of the laser beam in real time, wherein the correcting is repeatedly performed while welding is in progress.

16. The method of claim 15, wherein the difference is calculated based on the encoder value of the target welding coordinates and an encoder value of the current position.

17. The method of claim 11, further comprising obtaining welding shape data during welding using the coaxial camera and feeding back process conditions during or after the step of correcting the position of the laser beam.

18. The method of claim 17, wherein feeding back the process conditions comprises adjusting laser power or a laser shape based on an analysis result of the welding shape.
